(19) United States
(12) Patent Application Publication
(10) Pub. No.: US 2005/0231728 A1
(43) Pub. Date: Oct. 20, 2005

(54) Q-point stabilization for linear interferometric sensors using tunable diffraction grating

(76) Inventors: Anbo Wang, Blacksburg, VA (US); Bing Yu, Blacksburg, VA (US)

Correspondence Address: Supervisor, Patent Prosecution Services;PIPER RUDNICK LLP, 1200 Nineteenth Street, N.W., Washington, DC, 20036-2412, US

(21) Appl. No.: 10/824,600

(22) Filed: Apr. 15, 2004

(51) Int. Cl. G01B 9/02

(52) U.S. Cl. 356/480

(57) ABSTRACT

A linear interferometric sensor system in which the light output from the interferometric sensor is optically bandpass filtered before conversion to an electrical signal by an adjustable diffraction grating and the center wavelength of the adjustable diffraction grating is controlled by a feedback circuit responsive to the steady state component of the electrical signal corresponding to the filtered sensor return. The adjustable may comprise a diffraction grating a diffraction grating mounted on a motor driven rotary stage. The invention is particularly useful in self calibrating interferometric/intensity-based sensor configuration, but is also applicable in a wide variety of linear interferometric sensor configurations.

This invention was partially made with Government support under grant number DE-FC3601GO11050 awarded by the U.S. Department of Energy. The Government may have certain rights in the invention.

### BACKGROUND OF THE INVENTION

1. Field of the Invention

The invention relates to optical sensors generally, and more particularly to linear interferometric optic sensors.

2. Discussion of the Background

Optical sensors (fiber optic or otherwise) may be either intensity based or interferometric. Intensity-based sensors are typically processed by detecting an intensity of light transmitted by, or attenuated by, the sensor as a function of a fluctuating measurand (e.g., pressure, temperature, etc.) The systems for processing the output of such sensors are relatively uncomplicated; however, they are sensitive to signal fading due to perturbations in operating parameters other than the measurand. Examples of intensity-based sensors include the pressure-induced long period grating sensors described in U.S. patent application Ser. No. 10/431,456, entitled “Optical Fiber Sensors Based On Pressure-Induced Temporal Periodic Variations In Refractive Index” filed on May 8, 2003.

Alternatively, interferometric sensors involve the creation of a plurality of interference fringes as a function of a fluctuating measurand. The processing systems for interferometric sensors, which must count these fringes, are typically more complex, and therefore more costly and slow, than the processing systems for intensity-based sensors. These systems are also subject to fringe direction ambiguity (i.e., a change in direction of the measurand at a peak or trough of a fringe may not be detected). However, interferometric sensor systems involving fringe counting are not as sensitive to non-measurand operating parameter drifts as intensity-based sensors.

Interferometric sensors often employ a Fabry-Perot cavity, which maybe formed in an optical fiber (referred to as an intrinsic Fabry-Perot sensor), or between an end of an optical fiber and a reflector (referred to as an extrinsic Fabry-Perot sensor, see U.S. Pat. No. 5,301,001). However, there are also other types of interferometric sensors (e.g., Fizeau cavities and Michelson, Mach-Zehnder, and Sagnac interferometers).

In order to simplify the processing requirements associated with interferometric sensors, some interferometric sensor systems are designed such that the operating range of the sensor is confined to a linear portion of a single interference fringe (about ⅙ of a period). Sensors such as these are referred to as linear interferometric sensors.

In order to maximize the sensitivity and the operating range of a linear interferometric sensor, it is necessary to construct the sensor so that in the absence of an applied measurand (e.g., pressure or force), the output intensity is in the optimal location of the sensor response. This optimal location of the sensor response in the absence of an applied measurand is commonly selected with the maximal sensitivity on the transfer function, which is the quadrature-point or Q-point in the case of a low-finesse F-P sensor. Unfortunately, maintaining the Q-point in the optimal location is difficult. For a system that uses an optical source centered at 1.3 μm, the quasi-linear part of a fringe corresponds to a change in cavity length of only about 100-250 nm, depending on the sensor structures. Assembling the sensor to fix the Q-Point in the optimal location requires assembly tolerances on the order of nanometers, which is very difficult. In addition, changes in the physical dimensions of the sensor due to thermal expansion or contraction resulting from temperature changes will cause a drift in the Q-Point from the optimal location.

Due to the aforementioned difficulties, active techniques to stabilize the Q-point have been developed. Known active Q-point stabilization techniques include using a servo-system (Yoshino et al., “Fiber-Optic Fabry-Perot Interferometer and Its Sensor Application,” IEEE Trans. On Microwave Theory and Techniques, vol. MTT-30, no. 10, pp. 1612-1620, October 1982), using a tunable light source (Alcoz, et al., “Embedded Fiber-Optic Fabry-Perot Ultrasound Sensor,” IEEE Trans. On Ultrasonics, Ferroelectrics, and Frequency Control,” Vol. 37 No. 4, pp. 302-306, July 1990; J. F. Dorighi, et al., “Stabilization of An Embedded Fiber Optic Fabry-Perot Sensor for Ultrasound Detection,” IEEE Trans. Ultrason. Ferroelectr. Freq. Control, Vol. 42, pp. 820-824, 1995), quadrature phase-shifted demodulation or dual wavelength modulation (N. Furstenau, et al., “Extrinsic Fabry-Perot Interferometer Vibration and Acoustic Sensor Systems for Airport Ground Traffic Monitoring,” IEEEProc. Optoelectron, 144, pp. 134-144, 1997; W. Pulliam, et al., “Micromachined, SiC Fiber Optic Pressure Sensors for High Temperature Aerospace Applications,” SPIE Proc.: Industrial Sensing Systems, edited by Anbo Wang and Eric Udd, SPIE Vol. 4202, pp 21-30, 2000; K. Murphy, et al., “Quadrature Phase-Shifted, Extrinsic Fabry-Perot Optical Fiber Sensors,” Optics Letters, Vol. 16, pp. 273-275, 1991; M. Schmidt, et al., “Fiber-Optic Extrnsic Fabry-Perot Interferometer Sensors with Three-Wavelength Digital Phase Demodulation” , Opt. Letters., Vol. 24, pp. 599-601, 1999), and direct spectrum detection (W. Pulliam, et al., “Micromachined, SiC Fiber Optic Pressure Sensors for High Temperature Aerospace Applications,” SPIE Proc.: Industrial Sensing Systems, edited by Anbo Wang and Eric Udd, SPEE Vol. 4202, pp. 21-30, 2000; C. Belleville, et al., “White-light Interferometric Multimode Fiber-Optic Strain Sensor,” Optics Letters, Vol. 18, No. 1, pp. 78-80, 1993; S. A. Egorov, et al., “Advanced Signal Processing Method for Interferometric Fiber-Optic Sensors with Straightforward Spectral Detection,” Proc. Sensors and Controls for Advanced Manufacturing, edited by B. O. Nnaji and A. Wang, SPIE Proc., Vol. 3201, pp. 44-48, 1998).

Each of the aforementioned Q-point stabilization techniques has drawbacks. The servo system method is straightforward and good for high-frequency signal measurements, but the reference constant voltage may not be constant because of temperature drift, static bias change and source power fluctuation. Adjusting the operating point by changing the bias current of a laser diode may cause optical power fluctuation and is sensitive to back-reflections. This technique is also subject to laser mode hopping and high cost. The quadrature phase-shifted demodulation or dual-wavelength interrogation was originally developed by Murphy et al., “Quadrature Phase-Shifted, Extrinsic Fabry-Perot Optical Fiber Sensors,” Optics Letters, Vol. 16, No. 4, pp. 273-275, February 1991; to solve the nonlinear transfer function and directional ambiguity problems in extrinsic Fabry-Perot interferometric sensors, but it may also be used for operating point stabilizing for sensors working in the linear region. However, it is possible that neither of the two quadrature channels operates at the optimal Q-point at a certain time, provided that a 90 degree phase shift can be maintained during the measurement, which is as hard to control as the operating point itself.

Strictly speaking, the spectrum detection method should not be categorized as a kind of operating-point stabilizing method, though linear response may be achieved. By using a diffraction grating or a Fizeau interferometer, the modulated broadband spectrum is detected by a CCD array and analyzed by a signal processing unit. This method (also called white light inteferometry) does not require the control of the Q-point of an FFPI (Fiber-optic Fabry-Perot Interferometer) sensor, provides the absolute and accurate value of the optical path difference in a sensing interferometer, and is insensitive to the power and spectral fluctuations of the light source. Its major disadvantage is that it is not suitable for real time detection of a broadband signal, such as an acoustic wave or a high frequency pressure, because a large amount of time is required to process the large amount of data from the CCD array. For example, the achievable frequency response is less than 10 kHz when using a spectrometer analyzer available from Ocean Optics. Another disadvantage of the spectrum detection is the high cost, especially for sensors operating at NIR wavelengths, where an expensive detector array must be used.

In recognition of the aforementioned issues, May et al. have proposed, as set forth in co-pending U.S. application Ser. No. 10/670,457, filed, Sep. 26, 2003, the content of which is hereby incorporated by reference herein, methods and apparatuses for stabilizing the Q-point of a linear interferometric sensor system in which the light output from the interferometric sensor is optically bandpass filtered and the center wavelength of an adjustable band-pass filtering device is controlled by a feedback circuit responsive to a steady state component of an electrical signal resulting from the conversion of the filtered optical return signal from the sensor.

In the preferred embodiment described in that application, an output of the interferometric sensor is connected to an electrically tunable optical filter. The filtered optical signal is converted to an electrical signal which is input to a feedback circuit that produces a feedback signal that is used to control an electrically tunable optical filter so that the Q point remains at a desired location. In a highly preferred embodiment, the feedback circuit comprises a low pass filter with an input connected to an output of a photodetector in the signal channel and an output connected to an input of a differential amplifier. A second input of the differential amplifier is connected to a reference voltage representing a desired set point. The output of the differential amplifier is connected to an electrical control input of the electrically tunable optical filter.

### BRIEF SUMMARY OF THE INVENTION

In the present invention, an output of the linear interferometric sensor illuminates an adjustable diffraction grating, such as a diffraction grating mounted on a motorized rotary stage. The diffracted light is converted to an electrical signal, and the steady-state component of the electrical signal is input to a feedback circuit. The feedback circuit generates a feedback signal that is fed to the motorized rotary stage to adjust the angle of the diffraction grating with respect to the optical return of the sensor, thereby setting the central wavelength of the received spectrum of light to a desired value so that the Q-point remains at a desired location. In a highly preferred embodiment, the diffracted light is collimated, and the output of the collimator is focused onto a multimode fiber connected to an optical spectrum analyzer or a photodetector.

The invention may be used with any type of linear interferometric sensor system, including but not limited to SCIIB systems, and with Fabry-Perot and Fizeau cavities as well as Michelson, Mach-Zehnder and Sagnac interferometers.

### BRIEF DESCRIPTION OF THE DRAWINGS

A more complete appreciation of the invention and many of the attendant features and advantages thereof will be readily obtained as the same become better understood by reference to the following detailed description when considered in connection with the accompanying drawings, wherein:

FIG. 1 is a plot of a normalized output of a low-finesse FFPI sensor as a function of the central wavelength of the interference fringe for Fabry-Perot cavities of various lengths.

FIG. 2 is a block diagram of a linear interferometric sensor system employing a rotatable diffraction grating according to an embodiment of the present invention.

FIG. 3 is a perspective view of a portion of an embodiment of the system of FIG. 2.

FIG. 4 shows plots of the diffraction angle of the rotatable diffraction grating of FIG. 1 and received bandwidth, both as a function of a central wavelength of light received.

FIG. 8 is a block diagram indicating a conventional SCIIB sensor system configuration.

FIG. 9 is a plot of intensity as a function of Fabry-Perot cavity length for the system of FIG. 8.

FIG. 10 is a plot of intensity as a function of cavity length slowing constraint of cavity length to a linear portion of a fringe.

FIG. 11 is a block diagram of a SCIIB system according to another embodiment of the invention.

### DETAILED DESCRIPTION

The present invention will be discussed with reference to preferred embodiments of linear interferometric sensor systems. Specific details are set forth in order to provide a thorough understanding of the present invention. The preferred embodiments discussed herein should not be understood to limit the invention. Furthermore, for ease of understanding, certain method steps are delineated as separate steps; however, these steps should not be construed as necessarily distinct nor order dependent in their performance.

Interferometric-intensity-based detection is a widely used demodulation technique in optical interferometric sensors, such as Fabry-Perot, Mach-Zehnder and Sagnac sensors. When a monochromatic light of wavelength λ is used to interrogate the sensors, the optical intensity of the interference between the sensing beam and the reference beam can be expressed as:
I=I₁I₂+2\sqrt{I₁I₂ cos φ}
where I₁ and I₂ represent the optical intensities of sensing beam and reference beam, respectively, and
φ=2π(nl)/λ
is the phase difference caused by the Optical Path Difference OPD (nl) between the two beams, where n is the refractive index of the medium and l is the physical path difference. The optical intensity arriving at the photodetector is a simple cosine function, referred to as fringes, of (nl), which is a function of the measurand and background perturbations. Obviously, sensors have zero sensitivity at the peaks or the valleys of the fringes, and the maximum sensitivity and most linear response at the Q-points, where φ=π/2+mπ, m=0, 1, 2, . . . . It is advantageous to design a sensor operating around the Q-points for the highest sensitivity and the lowest signal distortion. However, any sensor fabrication tolerance, temperature-induced drift, and other environment perturbations can easily drive a sensor away from the Q-points. Noticing that the interference fringes and thereby the Q-points are wavelength dependent for all interferometers, the operating points may be dynamically controllable by tuning the wavelength of the interrogating light to compensate for the phase drifts, that is

$$Δϕ = {Δϕ}_{( v λ )} + {Δϕ}_{λ} = \frac{2 π}{λ} Δ ( v λ ) - \frac{2 π ( v λ )}{{λ}^{2}} Δλ = 0$$

$$or$$

$$Δλ = \frac{λ}{( nl )} Δ ( nl )$$

where Δφ(nl) and Δφλ are the phase changes caused by environment disturbance Δ(nl) and wavelength tuning Δλ. Usually (nl) is at least one order larger than λ, which means a large drift can be compensated by a relatively small change of the wavelength. The wavelength tuning can be realized by using a tunable laser, though this may cause some problems, such as optical power fluctuation and sensitivity to back-reflections. For a broadband light source, the wavelength dependence of the interference fringe is much more complex than for a monochromatic source. The interference fringes are determined by not only the central wavelength, but also the spectrum width of the interrogation light. The total optical intensity arriving at the photodetector has to be computed by integration over the whole spectrum of the light source.

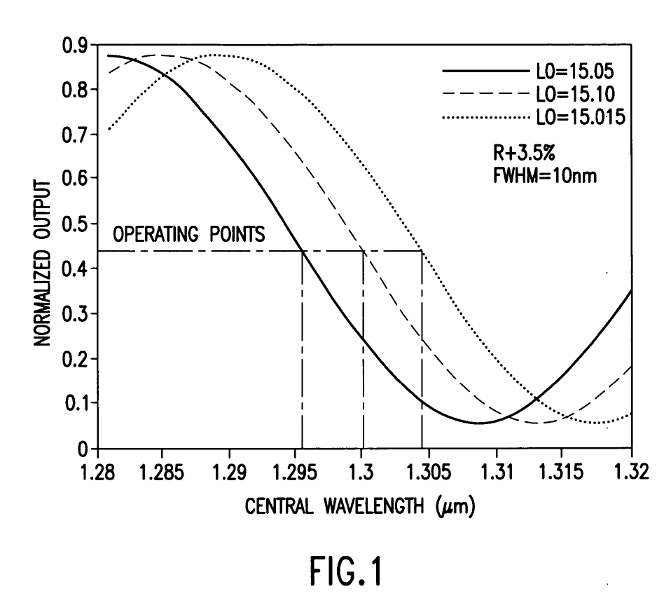

FIG. 1 is a theoretical calculation of the wavelength dependence of the interference fringes at different cavity lengths (L₀) of a low-finesse FFPI sensor, where a 1300 nm light source with a 35 nm (3-dB) spectral width was used, and the output is normalized to the source intensity distribution and the bandwidth of the interrogation lights is limited to 2Δλ=10 nm. As an example, if the OPD, for any reason, changes from L₀=15.05 μm to 15.15 μm, the Q-point can be tracked by tuning the central wavelength from 1.296 μm to 1.304 μm.

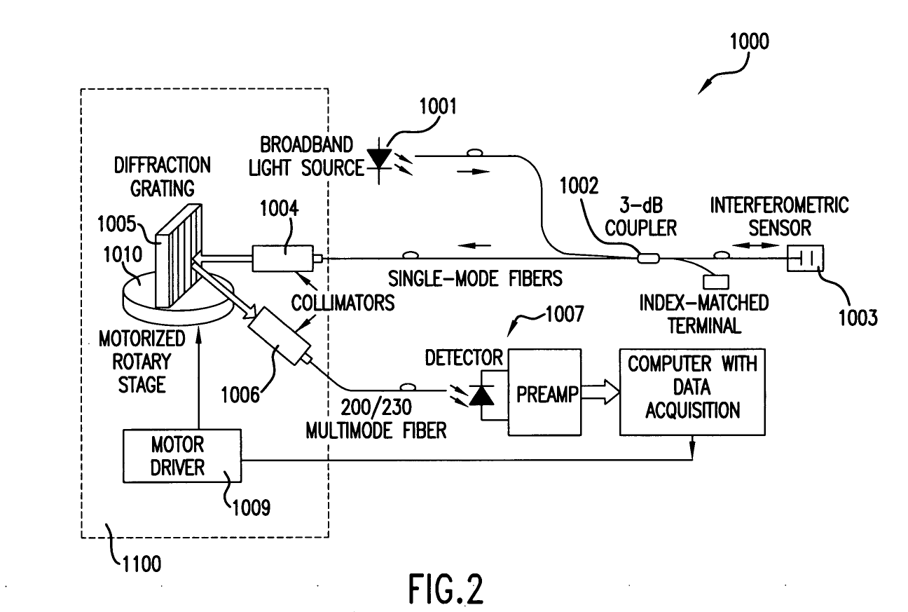

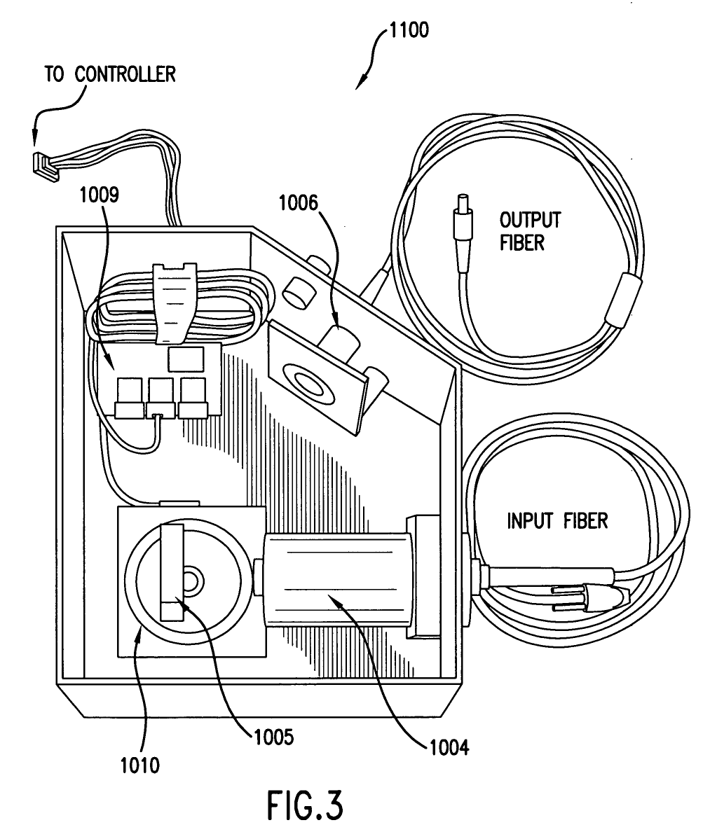

A linear interferometric sensor system 1000 with Q-point stabilization employing an adjustable grating system 1100 according to one embodiment of the present invention is illustrated in FIG. 2. Light from a broadband light source 1001, such as an SLED, is guided through a 3 dB 2×2 coupler 1002 into interferometric sensor 1003 such as an intrinsic or extrinsic fiber optic Fabry-Perot cavity. Reflections generated in the cavity 1003 are guided through the coupler 1002 to a first collimator 1004. The output of the first collimator 1004 illuminates a diffraction grating 1005, which is mounted on a motorized, rotary stage 1010. The motorized stage preferably can be adjusted with high resolution (e.g., approximately 0.2 mrad). The −1^{st} diffractions from the grating 1005 are collected by a second collimator 1006. An actual embodiment of portion 1100 of the system 1000, comprising the first and second collimators 1004, 1006, the diffraction grating 1005, the rotary stage 1010 and the motor driver 1009, is illustrated in FIG. 3.

In some embodiments, the collimated light from collimator 1006 is focused onto a 200/230 or a 100/140 multi-mode fiber (MMF). Only a part of the total spectrum (λ±Δλ) can be collected by the MMF. The use of an MMF increases the reception area and facilitates monitoring with the optical spectrum analyzer. In an alternative embodiment, a single mode fiber could be used.

In some embodiments, the output of the MMF (or single mode fiber) is directed to a photodetector 1007 as shown in FIG. 2. Alternatively, the output of the second collimator 1006 may be focused directly onto the photodetector 1007. The photodetector 1007 converts the optical output of the second collimator 1006 to an electrical signal, which is input to signal processor 1008. In alternative embodiments, the output of the second collimator 1006 is directed toward an optical spectrum analyzer (not shown in FIG. 2).

Signal processor 1008 isolates the steady state [as used herein, a “steady state component” of a signal represents a component of a signal that changes slowly as compared to changes in the signal resulting from changes in the measurand], or dc, component of the output of the photodetector 1007 from the transient, or ac, component. The signal processor may comprise analog or digital filters and/or may comprise a microprocessor (e.g., the signal processor may comprise a low pass filter to isolate the steady state, or dc, component and/or a high pass filter to isolate the transient, or ac component). The ac component represents the absolute value of the ac information of the perturbation signal, and its frequency response is limited only by the sensor-head and the bandwidth of the electronics circuits.

The dc, or steady state, component of the photodetector 1007 output represents the Q-point of the sensor. The signal processor 1008 compares this to a desired voltage, or set point, to generate a feedback signal to the motor drive 1009 of the motorized rotary stage 1010 on which the diffraction grating is mounted. This causes the stage 1010 on which the grating 1005 is mounted to rotate so that the Q-point of the sensor is maintained at the desired location represented by the set point. As will be discussed further below, the desired Q-point may be at a mid-point of a fringe or may be near a top or bottom of a fringe depending upon which directions perturbations in a measurand are expected and/or allowed. A wide variety of feedback circuits may be employed to produce the feedback signal output to the motor driver 1009. Furthermore, gratings that can be adjusted by other means may be used in place of the rotatable grating 1005.

According to the grating equation, the relationship between the incident beam and −1^{st} diffracted beam can be expressed as:
sin(A)+sin(B)=λ/d
where: A is the incident angle of the light beam from the input collimator respect to the normal of the grating surface;
B is the angle of the −1^{st} diffraction with respect to the normal of the grating surface;
λ is the wavelength of the light in air;
d is the groove spacing of the grating.
Assuming a lens of focal length f is used in the receiving collimator, we can calculate B by

$$cos ( B ) = \frac{f ( Δλ / D )}{d}$$

where Δλ—the spectrum resolution;
D is the diameter of the core of the receiving MMF or the active area of the detector.

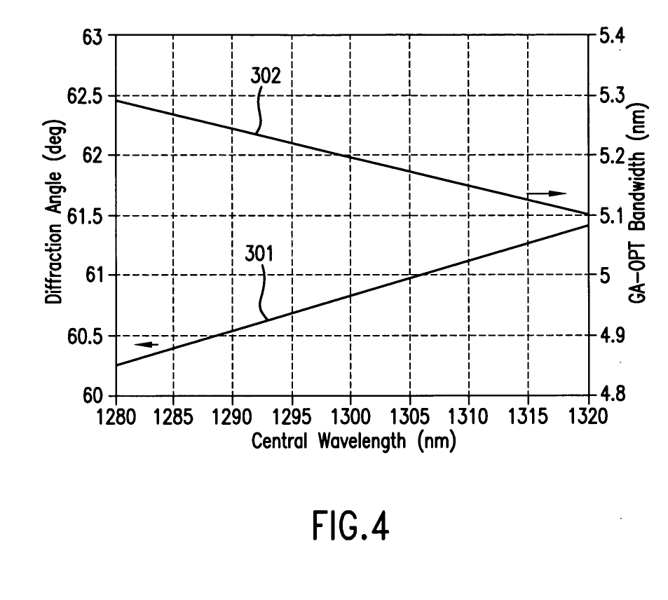

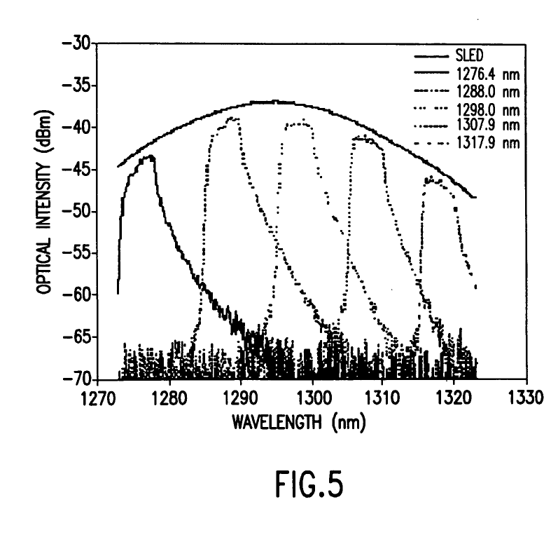

Choosing λ=1300 mm, d=1/750, f=25.0 mm, D=0.2 mm for a 200/2300 μm MMF, and B−A=55°, FIG. 4 shows the calculated angular tuning range (plot 301) for a wavelength tuning from 1280 nm to 1320 nm and the change in received bandwidth resulting from the change in angle of the grating with respect to the receiving device (plot 302). An angular change of 1.2°. is enough to scan a wavelength range of 40 nm, and a bandwidth change of about 3.5%. This bandwidth error may induce optical intensity distribution error out of the original light source distribution, but can easily be compensated by scanning the whole spectrum range and storing the new intensity distribution during the reset. Obviously, finer tuning or smaller Δλ can be realized, with the penalty of higher insertion loss, by using smaller diameter fiber D or longer focal length f if the groove spacing, incident angle A and diffraction angle B have been determined.

An adjustable grating system has been designed and fabricated, as shown in FIG. 3. A holographic diffraction grating of 750 grooves per millimeter was glued onto a motorized rotary stage 1010. The motor has a step resolution of 0.2-mrad and a rotation speed of 2 RPM, which means a central wavelength resolution of 0.38 nm and a tuning speed of 400 nm/s can be achieved. Collimator 1006 is the output collimator which has a focal length of 25 mm. The input single-mode fiber is connected to an interferometric optical sensor 1003, while the output 200/230 μm multimode fiber is connected to an optical receiver. A control interface board 1009 interconnects the motor and the motor controller (not shown). A 1296 nm SLED with a spectrum width of 35 nm was used as the broadband source 1001. FIG. 5 illustrates the spectrums received by the detector 1007 at different grating positions or central wavelengths (1276.4 nm, 1288.0 nm, 1298.0 nm, 1307.9 nm, and 1317.9 nm) and the original spectrum of the SLED, where the sensor was replaced with a cleaved single-mode fiber. By scanning the grating by an angle of 1.2°, a central wavelength change of 40 nm was achieved. This agrees well with the theoretical calculation shown in FIG. 4. The resulting spectrum bandwidth (FWHM) is between 4.30 and 4.65 nm, an average of 0.7 nm less than the theoretical results. This is believed being caused by the misalignments between the 25 mm lens in collimator 1006 and the 200/230 μm MMF was well as the relatively small aperture of collimator 1006 in the system used for the test. The total insertion loss is about 11 dB. As mentioned above, a tradeoff must be made between large bandwidth for high optical power and small bandwidth for high fringe visibility and high resolution of Q-point tuning.

The wavelength scan outputs of a FFPI sensor and the theoretical results in atmospheric pressure are shown in FIG. 6a. The unequal peak amplitudes are because of the Gaussian spectrum distribution of the 1296 nm SLED source. The peak position differences between the experimental results and the theoretical calculation are caused by the cavity length measurement error, while the amplitude differences are believed being caused by the offset of the spectrum distribution from the idea Gaussian distribution used of the calculation and the misalignments of the GA-OPT or the sensor FP cavity. FIG. 6b gives the scan outputs of a FFPI sensor in the atmosphere environment and under 50 cm water normalized to the source spectrum. A Q-point drift of about 3 nm was resulted because of the 50 cm static water-pressure. Obvious, there are more than one Q-point on the fringes, but only those two Q-points on the highest fringe have the best signal-to-noise ration, and thereby are suitable for an optimal operation-point.

A diaphragm-based FFPI acoustic wave sensor as described in Bing Yu, et al., “Fiber Fabry-Perot Sensors for Partial Discharge Detection in Power Transformers,” Applied Optics, Vol. 42, No. 16, pp. 3241-50, 2003, was chosen to test the performance of the developed adjustable grating system of FIG. 3 in practical applications. This sensor was designed for partial discharge detection in power transformers. Since this sensor was fabricated using thermal fusion bonding which might cause large cavity length error and may suffer from high static pressure in a transformer tank full of mineral oil, Q-point control has been a major challenge, and very low sensitivity may result. A scan output of this sensor in-an acoustic wave test setup is given in FIG. 7a with the acoustic wave outputs at the marked points A-E shown in FIG. 7b with that from a sensor system without a adjustable grating Q-point stabilization. Obviously, the original system has very low signal-to-noise ration (SNR) because of the short coherence length of the SLED source comparing to the sensor's cavity length and/or the unknown operation-point. When an adjustable grating system is used, the sensor has different performances at different operation-points. At points A and C, the Q-points of the interference fringes, the sensor has the best SNR that is attributed to the highest sensitivity of the Q-point and the increased fringe contrast. An SNR improvement of about 15 dB can easily be achieved over the original sensor even if it was operating at its Q-point. The sensor's SNR has only moderate improvement at points D and E, though they are Q-points too, because of the lower fringe slope at D or low absolute optical intensity at E, both caused by the non-flat SLED spectrum. The sensor has the lowest SNR at B because of the zero sensitivity at the fringe peaks (or valleys). Therefore, points A and C are the idea Q-points of this FFPI sensor. Also, the acoustic wave outputs at these two points have different polarities and different dynamic ranges that may be sensitive for some measurements. When the Q-point is determined, they can be maintained by feedback control system shown in the system diagram of FIG. 2.

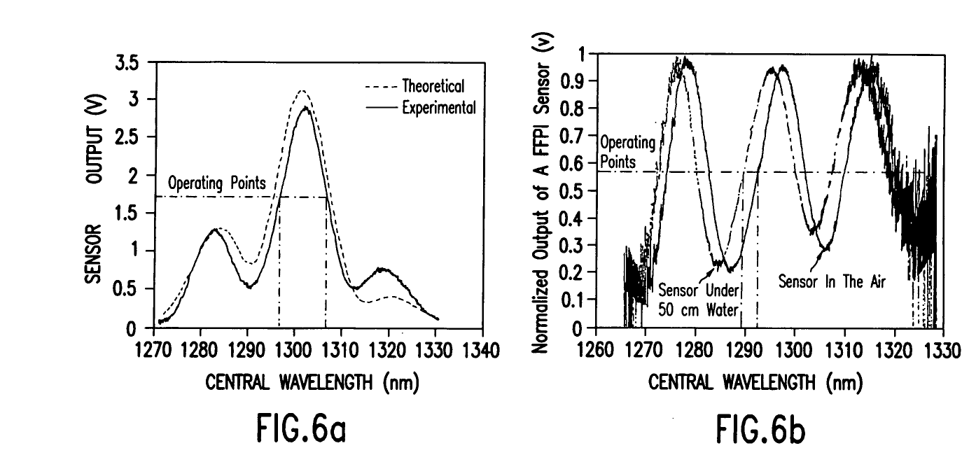

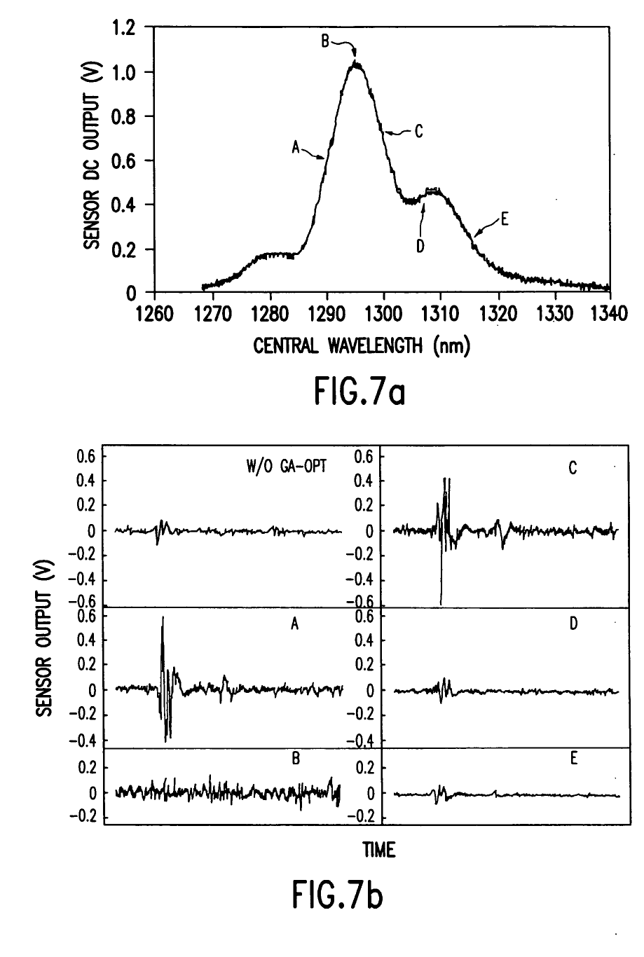

As discussed above, the invention may be used to stabilize the Q-point of any type of linear interferometric sensor configuration, including the SCIIB sensor configuration. A conventional SCIIB sensor configuration 100 is illustrated in FIG. 8. In the SCIIB sensor configuration 100, light from a broadband source 1 is guided though a 2×2 coupler 2 into an interferometric sensor such as a Fabry-Perot cavity 3. Reflections are generated by the two reflectors in the cavity 3, which are guided through the coupler to a first lens 4, which collimates the light. This collimated light is split into two beams by a beam splitter 5. One beam (in the signal channel) is passed through an optical band pass filter 6, to reduce the spectral width of the light. After it passes through the filter 6, it passes through a second lens 7, which serves to focus it onto a photodetector 8a. A preamp 8b is then used to convert the photo current to a voltage. The other beam (the reference channel) passes through a third lens 9 and is focused on a second photodetector 10a, without optical filtering. The output of the photodetector 10a is converted to a voltage by preamp 10b.

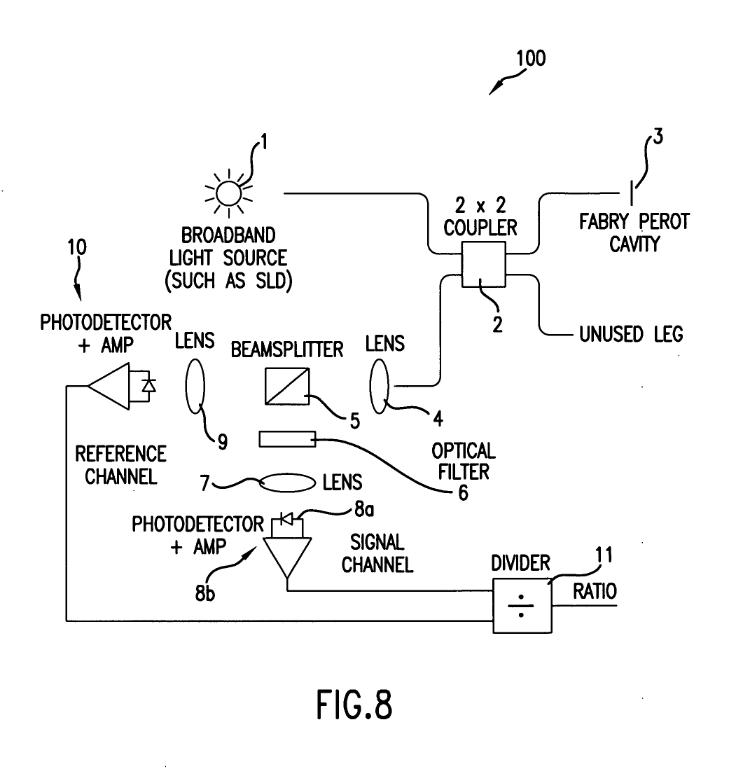

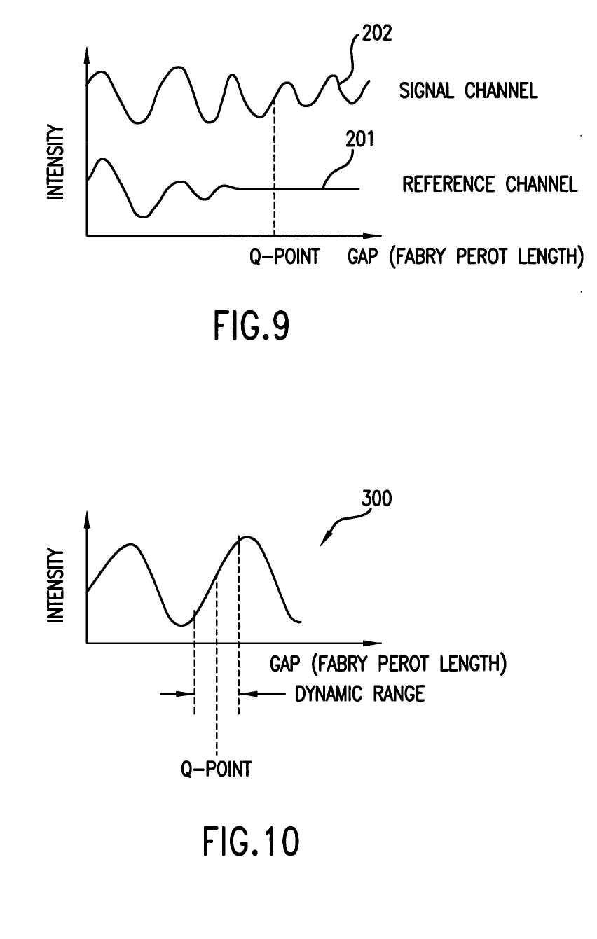

In the SCIIB sensor configuration 100, the optical path length of the cavity 3 is chosen to exceed the coherence length of the broadband light source 1, so that no interference is exhibited in the output of the reference channel. However, the spectral width of the light beam in the signal channel is narrowed by optical filter 6 such that its coherence length exceeds the optical path length of the cavity 3. This results in observable interference in the signal channel as illustrated by the signal channel plot 202 of FIG. 9. By taking the ratio of the signal channel to the reference channel at divider 11, effects that are common mode to both channels (such as fiber bend loss or source fluctuations) are canceled out.

To simplify the processing required for non-linear interferometric sensors, the Fabry-Perot cavity 3 is preferably constructed so that the voltage output from the pre amp 86 remains within the quasi-linear part of one of the fringes (about ⅙ of a period) as shown in FIG. 10. In that case, the output intensity from the cavity 3 is linearly proportional to the length of the cavity. The length of the cavity in turn changes in response to an applied pressure, or an applied load (force), so the output intensity can be related to pressure or force.

In the present invention, the fixed optical filter 6 in the signal channel of the conventional SCIIB system 100 of FIG. 8 is replaced with a rotatable diffraction grating and the center wavelength of the rotatable diffraction grating is adjusted so that the output intensity is midway (at the center) of the quasi-linear part of a fringe to achieve active Q-Point stabilization.

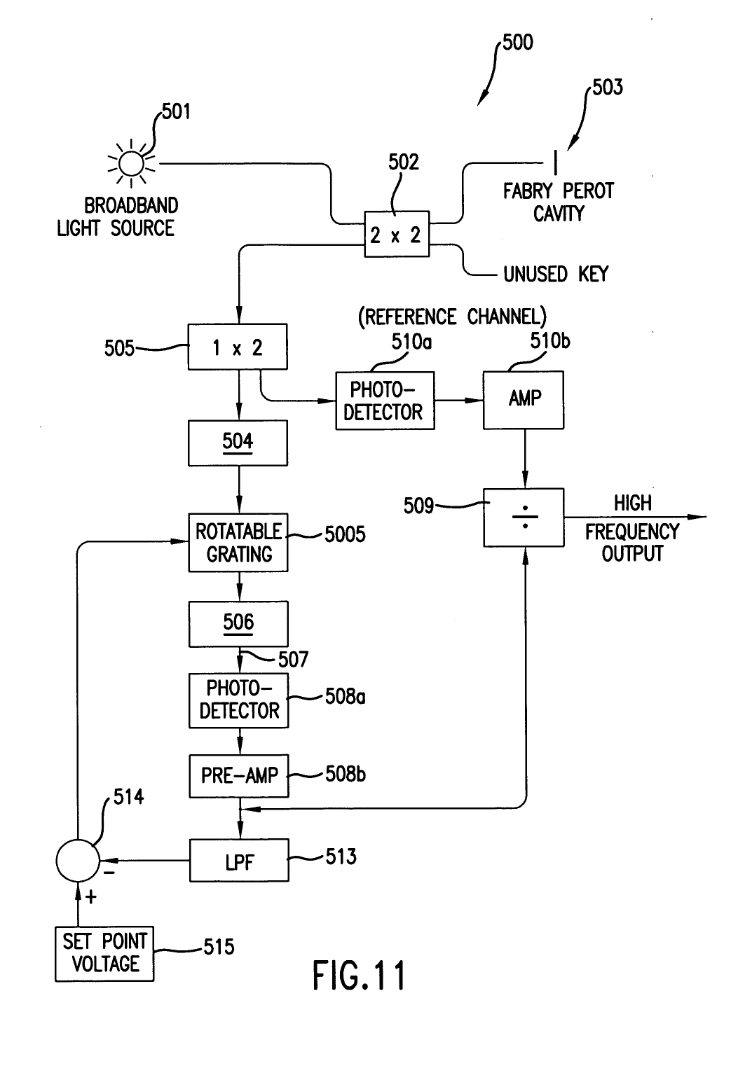

An example of such a system 500 is illustrated in the block diagram of FIG. 11. Light from broadband source 501 passes through a 3 dB (50%-50%) 2×2 coupler 502 to a Farby-Perot cavity (or other interferometric sensor) 503. Reflected light from the cavity 503 passes back through the coupler 502 to a 1×2 splitter 505. The 1×2 splitter may be, e.g., a 95%-5%, 90%-10%, or an 80%-20% splitter. Light from the dominant side (the side with the larger portion of the light, e.g. 90% of the splitter 505 (which forms the signal channel) enters collimating lens 504, which directs the light toward the rotatable diffraction grating 5005. Light from the diffraction grating 5005 is focused by collimating lens 506 and thru is guided by optical fiber 507 to photodector 508a. The output of the preamp 508b connected to the photodetector 508a in the signal channel is tapped off and directed to a low pass electronic filter (LPF) 513. The filter 513 blocks the high frequency content of the signal channel, and passes only the slowly varying signal, which would include slow mechanical and thermal drifts from the sensor cavity 503. This low frequency signal is then applied to the inverting input of an amplifier 514 (such as an op amp set up as a differential amplifier). A fixed voltage 515 (the set point voltage) is applied to the positive input of the amp 514. If the output of the low pass filter 513 equals the set point voltage 515, then the amp 514 outputs zero voltage. If the low pass filter 513 output differs from the set point voltage 515, then an error signal voltage is generated by the amp 514. This error voltage is applied to the motor driver input of the rotatable diffraction grating 1005/1010. “Rotatable diffraction grating 1005/1010” refers to a combination such as the diffraction grating 1005 and motorized stage 1010 of FIG. 2. The error voltage output by the amp 514 causes rotatable diffraction grating 1005/1010 to adjust the center wavelength of its passband so that the center wavelength corresponds to the midpoint of a fringe. With this change in wavelength passed by the diffraction grating 1005, the low frequency signal passed by the low pass filter 513 changes. If the Q-Point is at the desired location, then the voltage out of the low pass filter 513 equals the set point voltage 515 and the error voltage generated by the amp 514 would again be zero.

If the only effect causing a change in the sensor cavity length is thermal drift due to the chance in temperature, then the error signal from this servo control system is proportional to temperature, and it would be possible to use the error signal to measure temperature.

It will be recognized by those of skill in the art that the rotatable diffraction grating maybe used in a wide variety of other linear interferometric sensor systems. The electrically tunable optical filter disclosed in U.S. patent application Ser. No. 10/670,457 and the rotatable diffraction grating 1005 each have advantages and disadvantages that may make one or the other more suited to a particular application. For example, the rotatable diffraction grating has a wider bandwidth than the electrically tunable optical filter. On the other hand, the electrically tunable filter has a faster response time than the rotatable optical grating.

Various embodiments of linear interferometric sensor systems in which Q-point stabilization is achieved by bandpass filtering an optical output of an interferometric sensor, which an electrically adjustable grating converting the optical output to an electrical signal, comparing a steady state component of the electrical signal that is representative of the Q-point rather than changes in the measurand to a set point, generating a feedback signal based on the comparison, and using the feedback signal to adjust a center wavelength of the electrically adjustable grating to maintain the Q-point in a desired location.

While the invention has been described with respect to certain specific embodiments, it will be appreciated that many modifications and changes may be made by those skilled in the art without departing from the spirit of the invention. It is intended therefore, by the appended claims to cover all such modifications and changes as fall within the true spirit and scope of the invention.

1. A method for controlling a quiescent point of a linear interferometric sensor system comprising the steps of:
illuminating an interferometric sensor with a light source;
filtering light reflected by the interferometric sensor with an adjustable grating, the adjustable grating having a pass band, the pass band having a center frequency;
converting the filtered light to an electrical signal;
generating a feedback signal based on a steady state component of the electrical signal and a set point; and
using the feedback signal to control the adjustable grating such that a quiescent point of the sensor system is maintained at a desired location corresponding to the set point.

2. The method of claim 1, wherein the interferometric sensor comprises a Fabry-Perot cavity.

3. The method of claim 1, wherein the interferometric sensor comprises a Fizeau cavity.

4. The method of claim 1, wherein the interferometric sensor is a fiber optic sensor.

5. The method of claim 1, wherein the interferometric sensor is a Michelson interferometer.

6. The method of claim 1, wherein the interferometric sensor is a Mach-Zehnder interferometer.

7. The method of claim 1, wherein the interferometer sensor is a Sagnac interferometer.

8. The method of claim 1, wherein the diffraction grating is mounted on a motorized rotatable stage.

9. The method of claim 1, further comprising the step of collimating light diffracted by the adjustable grating.

10. The method of claim 9, further comprising the step of passing the collimated light to a photodetector.

11. The method of claim 10, wherein the light is passed to the photodetector through a multimode fiber.

12. The method of claim 9, further comprising the step of passing the collimated light to an optical spectrum analyzer.

13. The method of claim 1, further comprising the step of filtering the electrical signal with a low pass filter to isolate the steady state component of the electrical signal.

14. The method of claim 1, wherein the interferometric sensor system is a self-calibrating interferometric/intensity-based (SCIIB) system in which light with a coherence length less than a cavity length of the interferometric sensor is used to illuminate the interferometric sensor, light reflected by the interferometric sensor is split into a reference channel and a signal channel and the filtering step is performed only for light in the signal channel, the light in the reference channel and the filtered light in the signal channel are converted into corresponding electrical signals, and a ratio of the corresponding electrical signals is formed to cancel effects common to both channels.

15. A linear interferometric sensor system comprising:
a light source;
an interferometric sensor;
a coupler connected to the light source and the interferometric sensor;
an adjustable grating connected to the coupler to receive light reflected by the interferometric sensor, the adjustable device having a pass band, the adjustable device being configured to filter out light reflected by the interferometric sensor at frequencies outside of the pass band and pass light reflected by the interferometric sensor within the pass band;
a first photodetector connected to convert light passed by the adjustable grating into a first electrical signal;
a feedback circuit connected to receive the first electrical signal from the first photodetector, the feedback circuit being configured to output a feedback signal to control the adjustable device such that a quiescent point of the sensor system remains at a desired location, the feedback signal being based on a steady state component of the electrical signal and a set point corresponding to the desired location.

16. The system of claim 15, wherein the interferometric sensor comprises a Fabry-Perot cavity.

17. The system of claim 15, wherein the interferometric sensor comprises a Fizeau cavity.

18. The system of claim 15, wherein the interferometric sensor is a fiber optic sensor.

19. The system of claim 15, wherein the interferometric sensor is a Michelson interferometer.

20. The system of claim 15, wherein the interferometric sensor is a Mach-Zehnder interferometer.

21. The system of claim 15, wherein the interferometric sensor is a Sagnac interferometer.

22. The system of claim 14, wherein the adjustable grating is a grating mounted on a motor driven rotatable stage.

23. The system of claim 14, further comprising the step of collimating light diffracted by the adjustable grating.

24. The system of claim 14, wherein the light is passed to the first photodetector through a multimode fiber.

25. The system of claim 14, wherein the first photodetector forms part of an optical spectrum analyzer.

26. The system of claim 14, wherein the feedback circuit includes a low pass filter to isolate the steady state component of the electrical signal.

27. The system of claim 14, further comprising:
a beam splitter connected between the coupler and the adjustable grating, the beam splitter being configured to split the light reflected by the interferometric sensor into a reference channel and a sensor channel, the sensor channel being connected to the first photodetector;
a second photodetector connected to convert light from the reference channel into a second electrical signal; and
a divider connected to receive the first electrical signal and the second electrical signal and output a ratio of the first and second electrical signals.
